(19) United States
(12) Patent Application Publication
(10) Pub. No.: US 2021/0327417 A1
(43) Pub. Date: Oct. 21, 2021

(54) ELECTRONIC DEVICE AND CONTROL METHOD THEREFOR

(71) Applicant: LG ELECTRONICS INC., Seoul (KR)

(72) Inventor: Jonghoon CHAE, Seoul (KR)

(73) Assignee: LG ELECTRONICS INC., Seoul (KR)

(21) Appl. No.: 16/489,242

(22) PCT Filed: Feb. 1, 2019
(86) PCT No.: PCT/KR2019/001423

§ 371 Date: Aug. 27, 2019

(51) Int. Cl. G10L 15/22; G10L 17/26; G10L 17/12; G09B 19/00

(52) U.S. Cl. CPC G10L 15/22; G10L 17/26; G10L 17/12; G10L 2015/228; G10L 2015/225; G10L 2015/227; G09B 19/00

(57) ABSTRACT

Disclosed is an electronic device that provides a parenting guide based on voice recognition. In the electronic device including a parenting assistance agent operated by one of a standby mode and an active mode, the device includes a microphone that senses sound, and a controller that converts, when characteristic information corresponding to sound sensed through the microphone in the standby mode satisfies a preset crying sound criteria, an operation mode of the parenting assistance agent into an active mode, extracts parenting data corresponding to analyzed situation information after analyzing situation information related to the sound, and outputs parenting guide information corresponding to the extracted parenting data. A user interface to which artificial intelligence (AI) is applied is provided through the electronic device.

### CROSS-REFERENCE TO RELATED APPLICATIONS

This application is the National Stage filing under 35 U.S.C. 371 of International Application No. PCT/KR2019/001423, filed on Feb. 1, 2019, the contents of which are hereby incorporated by reference herein in its entirety.

### TECHNICAL FIELD

The present invention relates to an electronic device capable of recognizing a voice.

### BACKGROUND ART

Recently, the artificial intelligence technology, that implements by the computing technology the human thinking process, that is, recognition, inference, study, and the like, rapidly grows, along with the hardware development.

The artificial intelligence (AI) technology may be an object of study per se, and can provide various functions by being combined directly or indirectly with other fields of computer science. Especially, by introducing artificial intelligence elements in various fields of information technology, attempts to utilize them in solving problems in the field are very actively made.

The AI technology is divided into strong artificial intelligence and weak human intelligence. Strong AI is a technology that can make similar thinking and decision-making as humans, and it is a technology that learns by itself and makes its own judgment. Weak AI is a technology that provides optimal solution by performing cognitive processes such as perception and reasoning through calculation model. The artificial intelligence field can be classified into five key technologies: learning and reference technology, situational understanding technology, language comprehension technology, visual understanding technology, recognition and cognitive technology.

Recently, artificial intelligence speakers with voice recognition function that corresponds to language comprehension technology are being released.

Recently, speaker-type electronic devices have emerged that recognize a user's voice and act on recognized voice information. These electronic devices are undergoing a number of changes throughout the user's life as artificial intelligence is applied.

Thus, the needs of users wanting to use these electronic devices to provide various functions have increased, and various functions related to electronic devices are being developed to meet the needs of such users.

### DISCLOSURE OF THE INVENTION

Therefore, an object of the present invention is to provide the user with the necessary parenting guides, only by recognizing the crying sound of infants.

### Technical Solution

To achieve these and other advantages and in accordance with the purpose of the present disclosure, as embodied and broadly described herein, there is provided an electronic device including a parenting assistance agent operated in one of a standby mode and an active mode, which includes a microphone configured to sense sound, and a controller which, when characteristic information corresponding to the sound sensed through the microphone in the standby mode is met with the preset crying sound criteria, converts the operational mode of the parenting assistance agent to the above active mode, analyzes the situation information associated with the above sound and extracts parenting data corresponding to the analyzed situation information, and outputs parenting guide information corresponding to the extracted parenting data.

In one embodiment, the controller, based on the output of the above parenting guide information, may maintain the microphone in an active state for a set period of time and extract feedback information from the sound collected during the above preset time.

In one embodiment, the controller may further correct the parenting information corresponding to the analyzed situation information, using the extracted feedback information.

In one embodiment, the controller may further maintain the microphone in an active state for a preset time for new parenting guide information to be inputted when the extracted feedback information includes negative information on the parenting data corresponding to the analyzed situation information.

In one embodiment, the controller may further update the parenting data corresponding to the analyzed situation information with the new parenting guide information.

In one embodiment, the controller may further correct the accuracy point for child care data corresponding to the analyzed situation information, depending on whether the extracted feedback information includes positive information on the parenting data corresponding to the analyzed situation information.

In one embodiment, the controller may further add accuracy points to the parenting data corresponding to the analyzed situation information, when the extracted feedback information includes positive information on the parenting data corresponding to the analyzed situation information, and when the extracted feedback information includes negative information on the parenting data corresponding to the analyzed situation information, deduct accuracy points to the parenting data corresponding to the analyzed situation information.

In one embodiment, the controller may further delete parenting data corresponding to the analyzed situation information when the accuracy point does not meet the preset satisfaction criteria with respect to the parenting data corresponding to the analyzed situation information.

In one embodiment, the situation information may include at least one of the following information: date information, information of day of the week, time information, weather information, and location information that the sound is collected through the microphone, and characteristic information of the crying sound corresponding to the above collected sound.

In one embodiment, the controller may extract parenting data that matches with the situation information at the time the sound was collected from the parenting guide database, which includes plural parenting data matching, respectively, with at least one of the above situation information.

### Advantageous Effect

As described above, the present invention may activate parenting assistance agents with crying sounds as a starter word and provide parenting guides to users based on detected crying sounds and parenting data. Therefore, the user can be provided with a parenting guide without further manipulation to be provided with the parenting guide, since the parenting assistance agent is activated as the starter word for crying sound.

Furthermore, the present invention may provide an electronic device that can extract feedback information on the provided parenting guides and reflect extracted feedback information on the parenting data. Thus, by updating the existing parenting data, customized parenting guides can be provided with a greater reliability.

### BRIEF DESCRIPTION OF THE DRAWINGS

FIG. 1 is a block diagram illustrating an electronic device related to the present invention;

FIG. 2 is a perspective view illustrating an electronic device related to the present invention viewed from a side;

FIG. 3 is a flowchart illustrating a method for providing a parenting guide through an electronic device in accordance with the present invention;

FIG. 4 is a conceptual view illustrating an embodiment of a parenting guide database of an electronic device in accordance with the present invention;

FIG. 5 is a conceptual view illustrating a method in which an electronic device provides a parenting guide with a crying sound as a starter word in accordance with the present invention;

FIG. 6 is a flowchart illustrating a process to update a parenting data, using feedback information on a parenting guide provided by an electronic device in accordance with the present invention;

FIG. 7A is a conceptual view illustrating an embodiment in which an electronic device provides parenting guide in accordance with the present invention;

FIG. 7B is a conceptual view illustrating an embodiment of a parenting guide database using feedback of an electronic device in accordance with the present invention;

FIG. 8 is a flowchart illustrating a parenting guide provided by an electronic device and a feedback analysis thereon in accordance with the present invention;

FIGS. 9A and 9B are conceptual views illustrating embodiments of parenting guide and feedback analysis of an electronic device in accordance with the present invention; and

FIGS. 10A and 10B are conceptual views illustrating other embodiments of parenting guide and feedback analysis of an electronic device in accordance with the present invention.

### MODES FOR CARRYING OUT THE PREFERRED EMBODIMENTS

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In describing the present disclosure, if a detailed explanation for a related known function or construction is considered to unnecessarily divert the gist of the present disclosure, such explanation has been omitted but would be understood by those skilled in the art. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the another element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

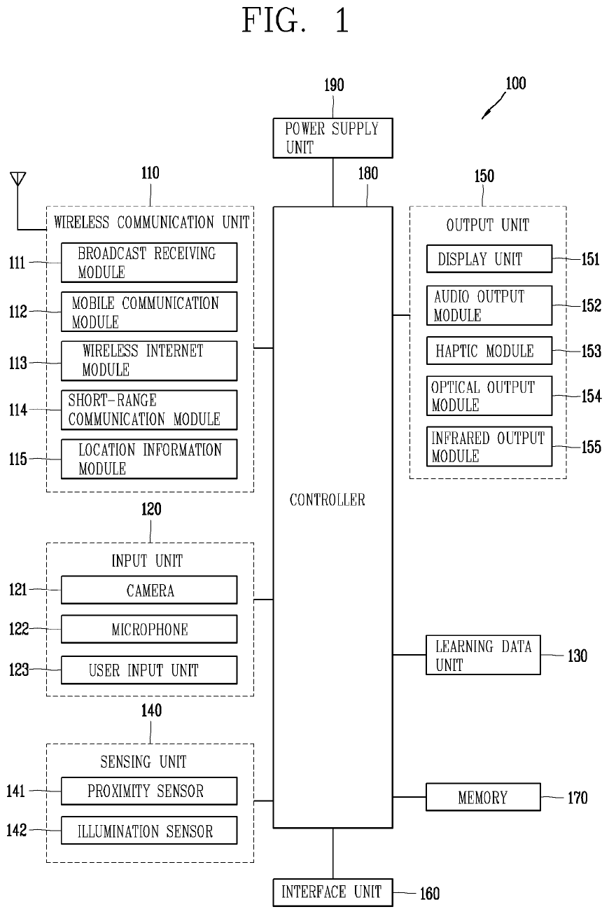

Referring to FIG. 1, FIG. 1 is a block diagram of a mobile terminal in accordance with the present invention.

The mobile terminal 100 may include a wireless communication unit 110, an input unit 120, a sensing unit 140, an output unit 150, an interface unit 160, a memory 170, a controller (or control unit) 180, a power supply unit 190, etc. It is understood that implementing all of the illustrated components is not a requirement. Greater or fewer components may alternatively be implemented.

In more detail, the wireless communication unit 110 may typically include one or more modules which permit communications such as wireless communications between the mobile terminal 100 and a wireless communication system, communications between the mobile terminal 100 and another mobile terminal, or communications between the mobile terminal 100 and an external server. Further, the wireless communication unit 110 may typically include one or more modules which connect the mobile terminal 100 to one or more networks.

The wireless communication unit 110 may include one or more of a broadcast receiving module 111, a mobile communication module 112, a wireless Internet module 113, a short-range communication module 114, and a location information module 115.

The input unit 120 may include a camera 121 or an image input unit for obtaining images or video, a microphone 122, which is one type of audio input device for inputting an audio signal, and a user input unit 123 (for example, a touch key, a mechanical key, and the like) for allowing a user to input information. Data (for example, audio, video, image, and the like) may be obtained by the input unit 120 and may be analyzed and processed according to user commands.

The sensing unit 140 may typically be implemented using one or more sensors configured to sense internal information of the mobile terminal, the surrounding environment of the mobile terminal, user information, and the like. For example, the sensing unit 140 may include at least one of a proximity sensor 141, an illumination sensor 142, a touch sensor, an acceleration sensor, a magnetic sensor, a G-sensor, a gyroscope sensor, a motion sensor, a red, green, and blue (RGB) sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like). The mobile terminal disclosed herein may be configured to utilize information obtained from two or more sensors of the sensing unit 140, and combinations thereof.

The output unit 150 may typically be configured to output various types of information, such as audio, video, tactile output, and the like. The output unit 150 may include at least one of a display unit 151, an audio output module 152, a haptic module 153, and an optical output module 154. The display unit 151 may have an inter-layered structure or an integrated structure with a touch sensor in order to implement a touch screen. The touch screen may function as the user input unit 123 which provides an input interface between the mobile terminal 100 and the user and simultaneously provide an output interface between the mobile terminal 100 and a user.

The interface unit 160 serves as an interface with various types of external devices that are coupled to the mobile terminal 100. The interface unit 160, for example, may include any of wired or wireless headset ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is implemented to store data to support various functions or features of the mobile terminal 100. For instance, the memory 170 may be configured to store application programs or applications executed in the mobile terminal 100, data or instructions for operations of the mobile terminal 100, and the like. At least one of these application programs may be downloaded from an external server via wireless communication. Other application programs may be installed within the mobile terminal 100 at time of manufacturing or shipping, which is the case for basic functions of the mobile terminal 100 (for example, receiving a call, placing a call, receiving a message, sending a message, and the like). Application programs may be stored in the memory 170, installed in the mobile terminal 100, and executed by the controller 180 to perform an operation (or function) for the mobile terminal 100.

The controller 180 functions to control an overall operation of the mobile terminal 100, in addition to the operations associated with the application programs. The controller 180 may provide or process information or functions appropriate for a user by processing signals, data, information and the like, which are input or output by the aforementioned various components, or activating application programs stored in the memory 170.

Also, the controller 180 may control at least some of the components illustrated in FIG. 1, to execute an application program that have been stored in the memory 170. In addition, the controller 180 may control at least two of those components included in the mobile terminal 100 to activate the application program.

The power supply unit 190 may be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least part of the components may cooperatively operate to implement an operation, a control or a control method of a mobile terminal according to various embodiments disclosed herein. Also, the operation, the control or the control method of the mobile terminal may be implemented on the mobile terminal by an activation of at least one application program stored in the memory 170.

Hereinafter, description will be given in more detail of the aforementioned components with reference to FIG. 1, prior to describing various embodiments implemented through the mobile terminal 100.

First, regarding the wireless communication unit 110, the broadcast receiving module 111 is configured to receive a broadcast signal and/or broadcast associated information from an external broadcast managing server via a broadcast channel. The broadcast channel may include a satellite channel, a terrestrial channel, or both. In some embodiments, two or more broadcast receiving modules may be utilized to facilitate simultaneous reception of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

The wireless signal may include various types of data depending on a voice call signal, a video call signal, or a text/multimedia message transmission/reception.

The wireless Internet module 113 refers to a module for wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), High Speed Uplink Packet Access (HSUPA), Long Term Evolution (LTE), LTE-advanced (LTE-A) and the like. The wireless Internet module 113 may transmit/receive data according to one or more of such wireless Internet technologies, and other Internet technologies as well.

When the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideB and (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

Here, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of at least part of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position (or current position) of the mobile terminal. As an example, the location information module 115 includes a Global Position System (GPS) module, a Wi-Fi module, or both. For example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module. If desired, the location information module 115 may alternatively or additionally function with any of the other modules of the wireless communication unit 110 to obtain data related to the position of the mobile terminal. The location information module 115 is a module used for acquiring the position (or the current position) and may not be limited to a module for directly calculating or acquiring the position of the mobile terminal.

Examples of such inputs include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. Meanwhile, the cameras 121 may be arranged in a matrix configuration to permit a plurality of images having various angles or focal points to be input to the mobile terminal 100. Also, the cameras 121 may be located in a stereoscopic arrangement to acquire left and right images for implementing a stereoscopic image.

The microphone 122 processes an external audio signal into electric audio (sound) data. The processed audio data can be processed in various manners according to a function being executed in the mobile terminal 100. The microphone 122 may include assorted noise removing algorithms to remove unwanted noise generated in the course of receiving the external audio signal.

The user input unit 123 is a component that receives an input of information from a user. Such user input may enable the controller 180 to control operation of the mobile terminal 100 in correspondence with the received information. The user input unit 123 may include one or more of a mechanical input element (for example, a mechanical key, a button located on a front and/or rear surface or a side surface of the mobile terminal 100, a dome switch, a jog wheel, a jog switch, and the like), or a touch-sensitive input element, among others. As one example, the touch-sensitive input element may be a virtual key, a soft key or a visual key, which is displayed on a touch screen through software processing, or a touch key which is located on the electronic device at a location that is other than the touch screen. On the other hand, the virtual key or the visual key may be displayed on the touch screen in various shapes, for example, graphic, text, icon, video, or a combination thereof.

The learning data unit 130 may be configured to receive, classify, store and output information that may be used for data mining, data analysis, intelligent decision, and machine learning and algorithm. The learning data unit 130 may include one or more memory units configured to store information received, detected, sensed, generated, or pre-defined through a terminal, or information outputted from the terminal in a different way, or otherwise data received, detected, sensed, generated, pre-defined, or outputted from other configuration, device and terminal.

The learning data unit 130 may include a memory combined with a mobile terminal or included therein. In one embodiment, the learning data nit 130 may be implemented through the memory 170. But not limited thereto, the learning data unit 130 may be implemented in a memory (for instance, an external memory connected wired (electrically) with the mobile terminal 100) associated with the mobile terminal 100, or a memory included in a server communicable with the mobile terminal 100. In other embodiment, the learning data unit 130 may be implemented by a memory that is maintained in a cloud computing environment, or other remote memory that is accessible through a terminal in a communication method like a network.

The learning data unit 130 may be typically configured to store the data in one or more data bases for identification, indexing, classification, manipulation, storage, retrieval and output of data for use in supervised or unsupervised learning, data mining, forecasting analysis, or other machine learning techniques. Information stored in the learning data unit 130 may be used by the controller 180 that uses at least one of the different types of data analysis, machine learning algorithm and machine learning techniques, or multiple controllers included in the mobile terminal. Examples of such algorithms and techniques may be K-Nearest Neighbor System, fuzzy logic (for instance, possibility theory), neutral networks, Boltzmann machines, vector quantization, pulsed neural nets, support vector machines, maximum margin classifiers, hill-climbing, inductive, logic systems, baysian networks, petrinets (for instance, finite state machines, mealy machines, moore finite state machine), classify trees (for instance, perceptron trees, support vector trees, decision tree forests, random forests), pendemenium models and systems, clustering, artificially intelligent planning, artificially intelligent forecasting, data fusion, sensor fusion, image fusion, reinforcement learning, augmented reality, pattern recognition, automated planning, and the like.

The controller 180 may be configured to determine or forecast at least one executable motion of a mobile terminal, based on information that is determined or generated by use of the data analysis, machine learning algorithm and machine learning technique. To this end, the controller 180 may request, search, receive, or utilize data of the learning data unit 130. The controller 180 may execute various functions that implement a knowledge-based system, an inference system and a knowledge acquisition system, and also may execute various functions including a system for uncertain inference (for instance, fuzzy logic system), an adaptation system, a machine learning system, an artificial neural network, and the like.

The controller 180 may include sub-modules that enable voice and natural language processing, such as I/O processing modules, environmental condition modules, sound-to-text (STT) processing modules, natural language processing modules, workflow processing modules, and service processing modules. Each sub-module may have access to one or more systems or data and models on the mobile terminal, or to their subset or superset. Here, targets with access to each of the sub-modules may include scheduling, vocabulary indexes, user data, task flow models, service models, and automated sound recognition (ASR) systems. In other embodiments, the controller 180 or the mobile terminal may be implemented as the sub-modules, systems, or data and models.

In some embodiments, the controller 180 may be configured, based on data of the learning data unit 130, to detect and sense what users require based on the contextual conditions expressed as user input or natural language input, or on the user's intention. Further, the controller 180 may be configured to actively elicit, or obtain, the information necessary to completely determine what the user needs, depending on the contextual conditions or the user's intentions. For instance, the controller 180 may detect and sense what users require by analyzing past data, including past inputs and outputs, pattern matching, unambiguous words, and input intentions. In addition, the controller 180 may determine the workflow for executing the functions required by the user, depending on context conditions or the user's intention. Further, the controller 180 may execute a workflow to meet the needs of users based on context conditions or the user's intention.

In some embodiments, the controller 180 may implement dedicated hardware elements for learning data processes, including memistors, memristors, mutual conductance amplifiers, pulsed neural circuits, artificial nano-technology systems (e.g., autonomous nano-machines), or artificial intelligence-type quantum machine systems (e.g., quantum neural networks). In some embodiments, the controller 180 may include pattern recognition systems such as machine vision systems, acoustic recognition systems, handwriting recognition systems, data fusion systems, sensor fusion systems and soft sensors. The machine vision system may include content-based image retrieval, optical character recognition, augmented reality, ego-motion, tracking and optical flow.

The controller 180 may detect or receive information in the mobile terminal, ambient environmental information surrounding the mobile terminal, or other information, through the sensing unit 140. In addition, the controller 180 may receive broadcast signals, and/or broadcast-related information, radio signals, and radio data, through the radio communications unit 110. Further, the controller 180 may receive input of video information (or corresponding signals), audio information (or corresponding signals), data, or information inputted from the user.

The controller 180 may collect information, and process or classify it (e.g., knowledge graphs, command policies, personalization databases, conversation engines, etc.) and store the information that has been processed or classified in the memory 170 or the learning data unit 130.

And, the controller 180 may control, when the operation of mobile terminal is determined based on data analysis, machine learning algorithm and machine learning technology through the learning data unit 130, the components of the mobile terminal to perform the determined operations. The controller 180 may execute the determined operations by controlling the mobile terminal, based on the control command.

In one embodiment, the controller 180 may analyze, when a particular operation is executed, historical information indicating the performance of a particular operation through data analysis, machine learning algorithms, and machine learning techniques, and execute updates on the existing learned information based on the analysis information. In this instance, the controller 180 along with the learning data unit 130 may enhance the accuracy of the future performance of the updated information-based data analysis, machine learning algorithms and machine learning technologies.

Meanwhile, the sensing unit 140 is generally configured to sense one or more of internal information of the mobile terminal, surrounding environment information of the mobile terminal, user information, or the like, and generate a corresponding sensing signal. The controller 180 generally cooperates with the sending unit 140 to control operations of the mobile terminal 100 or execute data processing, a function or an operation associated with an application program installed in the mobile terminal based on the sensing signal. The sensing unit 140 may be implemented using any of a variety of sensors, some of which will now be described in more detail.

The proximity sensor 141 refers to a sensor to sense presence or absence of an object approaching a surface, or an object located near a surface, by using an electromagnetic field, infrared rays, or the like without a mechanical contact. The proximity sensor 141 may be arranged at an inner area of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data (or information) according to whether a touch with respect to a point on the touch screen is either a proximity touch or a contact touch.

A touch sensor can sense a touch (or a touch input) applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which area of the display unit 151 has been touched. Here, the touch controller may be a component separate from the controller 180, the controller 180, and combinations thereof.

Meanwhile, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches include a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize location information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121, which has been depicted as a component of the input unit 120, includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors (TRs) at rows and columns to scan content received at the photo sensor using an electrical signal which changes according to the quantity of applied light. Namely, the photo sensor may calculate the coordinates of the physical object according to variation of light to thus obtain location information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

Also, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 may receive audio data from the wireless communication unit 110 or output audio data stored in the memory 170 during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceives, or otherwise experiences. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal therethrough. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a flash memory type, a hard disk type, a solid state disk (SSD) type, a silicon disk drive (SDD) type, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control operations relating to application programs and the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provides internal power and supply the appropriate power required for operating respective elements and components included in the wearable device 100 under the control of the controller 180. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

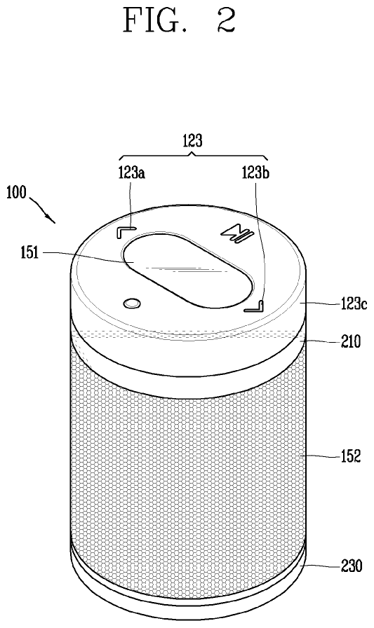

Hereinafter, description will be given of the electronic device including at least one of the elements described with reference to FIG. 1. FIG. 2 is a perspective view illustrating an electronic device related to the present invention, viewed from one side.

Referring to FIG. 2, the electronic device 100 may include a user input 123, an acoustic output 152 and a light output 154. The user input unit 123 may be configured to receive input of a control command from the user and may be provided singly or in plural. Hereinafter, the multiple user input units are described, named a first user input 123a, a second user input 123b, and a third user input 123c. Similarly, the light output unit 154 may be provided in plural, and is described by the names of a first light output unit 154a and a second light output unit 154b, respectively. If the multiple user input units and light input units are collectively referred to, they are described using reference numerals 123 and 154, respectively.

The body part 200 may be cylindrical, and it may have the ringing barrel. And the size of the body part 200 may be determined by considering the design. Meanwhile, the body part 200 may vary in form.

The body part 200 may be formed to face a first region 210 that forms a side of the cylinder, a second region 220 that forms a base plane of the cylinder and a third region 230 that faces to the second region 220 and forms the other base plane of the cylinder. The second region 220 and the third region 230 may have the same area or different areas.

The first region 210 may be referred to as an outer face, the second and third regions 220 and 230 may be referred to as an outer upper face and an outer lower face, but are described below using the terms “the 1st, 2nd and 3rd regions”.

In the first region 210, a third user input unit 123c, a second light output unit, an infrared output unit and an acoustic output unit 152 may be provided. For instance, a second light output unit and the acoustic output unit 152 may be formed apart from each other. Alternatively, with reference to FIG. 2, at least part of the second light output unit may be formed to overlap each other in the layer form, with the acoustic output unit 152. This can be easily changed by the designer's choice.

The second light output unit and the acoustic output unit 152 may be formed to enclose the first region 210 of the body part 200. Thus, the acoustic output unit 152 is formed such that sound is outputted in all directions based on the body part 200, and the second light output unit can output light in all directions based on the body part 200.

The third user input unit 123c may be disposed at the top of the first region 210. The third user input unit 123c may be formed to rotate around the center of the body part 200. Thus, the user can rotate the third user input unit to increase or decrease the volume of the audio device 100.

The infrared output unit may be disposed at a position where infrared signals can be outputted in all directions. For instance, an infrared output unit may be placed at the top of the first region 210. In another example, as shown in FIG. 2, it may be disposed at a region formed to be rotatable in the upper end of the first region 210. Thus, an infrared output unit may output infrared signals so that the infrared signals reach an external device located at any position. On the other hand, the location of the placement of the infrared power unit may be changed by the person skilled in the art to a position where the infrared signals can be outputted in all directions.

In the second region, a display unit 151, first and second user inputs 123a and 123b, a first light output unit and a temperature/humidity sensor may be disposed.

The display unit 151 may be disposed at the center of the second region 220 to secure the user's view. In the surrounding region of the display unit 151, the first and second user input units 123a and 123b may be disposed to receive user input.

The first and second user input units 123a and 123b may be formed in a button type to operate by being pressed or in a touch type to operate by being touched. The first and second input units 123a and 123b may be formed to perform different functions. For instance, the first user input unit 123a may be a button to enter a control command to stop the voice recognition, and the second user input unit 123b may be a button to input a control command to turn on/off the power.

The first light output unit 154a may be formed along the outside of the second region 220. That is, the first light output unit 154a may be formed in the band type to enclose the outside of the second region 200. For instance, the first light output unit 154a may be in the form of band surrounding a circle when the second region 200 is circular.

The light output unit may be formed to emit a light from the light source. Light emitting diodes (LEDs) may be used as the light source. The light source is located on the inner surface of the light output unit, and the light outputted from the light source is reflected externally through the light output unit. The light output unit may be made of transparent or translucent materials that light can penetrate.

The light output unit may output notification information related to events occurring in the audio device 100 as a light. For instance, when voice recognition is being executed on the audio device 100, red light can be outputted. Further, when the audio device 100 is waiting for a correction command, yellow light may be outputted.

The temperature/humidity sensor may be located at the second region 220 which is directly in contact with the outside to detect ambient temperature and humidity.

Though not shown, the third region 230 may be provided further with the power supply 190 for receiving the power from the outside, interfaces 160 for transmitting and receiving data to and from external devices, and audio inputs (microphone) for receiving sound.

Hereinbefore, the audio device 100 has been described in accordance with the present invention. In the above, the disposition of the components of the audio device 100 has been described, but the present invention is not limited thereto, and may vary the disposition of the components to the extent that it is readily available to the person skilled in the art.

Meanwhile, as described hereinbefore, the electronic device 100 in accordance with the present invention includes parenting assistance agents that provide information on parenting guides through voice recognition.

The parenting assistance agent means a processor that its driving mode is converted to an active mode through a crying sound as a starter word, and provides the user (or caregiver) with a customized guide in accordance with situations. In this instance, the agent is an autonomous processor that performs tasks on behalf of the user for a specific purpose, with the ability to recognize and respond to change in the environment by itself, and to learn based on experience.

The driving mode of the parenting assistance agent is defined as a standby mode and an activation mode.

The standby mode is a state that the parenting assistance agent does not perform a specific function, and the microphone 122 may be operated in an active mode in the standby mode.

In the standby mode, the microphone 122 may be activated in real time or detect ambient sounds at a preset time interval.

Moreover, in the standby mode, when the characteristic information of the sensed sound meets the preset criteria, the driving mode of the parenting assistance agent is converted to an active mode.

On the other hand, the active mode, based on the characteristic information of the sensed sound, is a mode of performing a specific function, where the specific function may be a function of providing guidance related to parenting.

Meanwhile, the characteristic information of sound may include at least one of the frequency of sound, the shape of the frequency waveform, the size of the sound, the duration of the sound, and the occurrence period of the sound. That is, the controller 180 may use at least one of plural characteristic or information that is combined by plural characteristic information to determine whether the characteristic information corresponding to the sensed sound meets the preset crying sound criteria.

Here, the characteristic information of sound is not limited to the examples as above, which is a distinguishing element for a specific type of sound. For instance, among various types of sounds, for instance, laughter, crying, and sighing, the controller 180 of the present invention may convert the parenting assistance agent into an active mode, depending on whether the sensed sound satisfies the characteristic information corresponding to the crying sound.

When the parenting assistance agent is converted into an active mode by crying sound as a starter word, the controller 180 may provide a parenting guide based on collected parenting data.

Meanwhile, for the purpose of explaining the present invention, the subject of crying sound is defined as ‘target’, and the object using the parenting guide provided with the crying sound of the target as the starter word is defined as ‘user’. Here, the subjects may include people or animals, especially infants, the elderly, or pets. In this instance, users may be caregivers of infants, protectors of elderly or cohabitants of animals.

In addition, for the examination purpose, the data matched with the sensed crying sound is described as a ‘parenting’ guide or ‘parenting’ data, but not limited to the ‘parenting’ and may be applied to other areas.

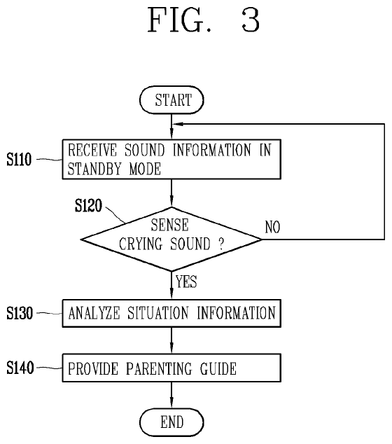

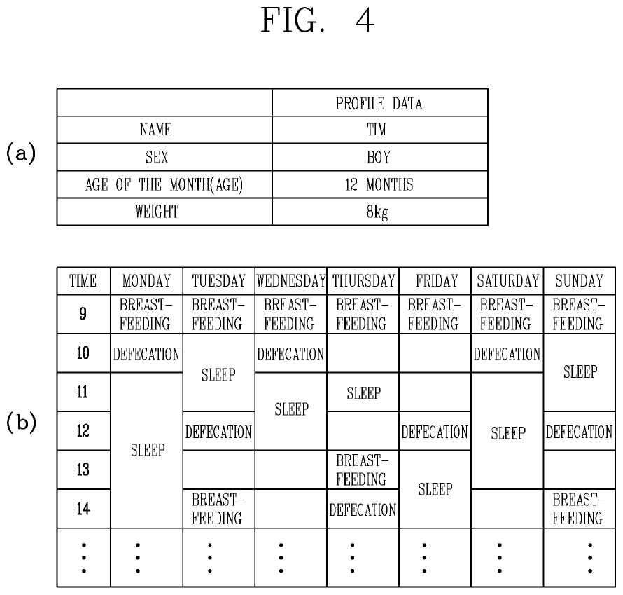

Hereinafter, the electronic device 100 that includes a parenting assistance agent will be more specifically described with reference to the drawings. FIG. 3 is a flowchart illustrating a method for providing a parenting guide through an electronic device in accordance with the present invention, and FIG. 4 is a conceptual view illustrating an embodiment of a parenting guide database of an electronic device in accordance with the present invention.

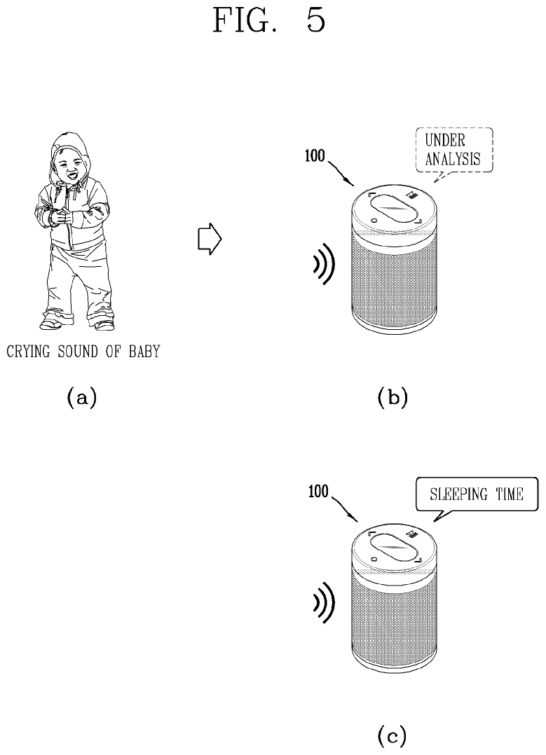

And FIG. 5 is a conceptual view illustrating a method that an electronic device provides a parenting guide with a crying sound as a starter word in accordance with the present invention.

The electronic device 100 including the parenting assistance agent in accordance with the present invention may include a microphone 122 and a controller 180.

First, the microphone 122 may be configured to sense sound. The microphone 122 may also sense sound under the control of the controller 180 in the standby mode and active mode of the parenting assistance agent.

On the other hand, the controller 18 may control the overall operations of the device, as well as controlling each component that makes up the electronic device 100.

Further, the controller 180 in accordance with the present invention may refer to the existing parenting guide database to extract and provide parenting guide data to users as needed.

Here, the parenting guide database refers to multiple parenting data related to parenting. In other words, the electronic device 100 in accordance with the present invention may provide parenting guides to users based on parenting data stored in the parenting guide database.

This parenting guide database may include at least one of the information collected from the user, the information entered by the user, and the information downloaded through the wireless communication unit 110. In addition, the parenting guide database may be stored in at least one of the internal memory 170 and external memory of the electronic devices 100. Meanwhile, the controller 180 in accordance with the present invention may extract parenting data by wired or wireless communication unit 110 from the parenting guide database stored in the external memory of the electronic device 100

Hereinafter, referring to FIGS. 3 to 5, description will be given of a parenting guide providing method of the electronic device 100 in accordance with the present invention.

First, the electronic device 100 in accordance with the present invention may include a microphone 122 that may sense sound (voice) in the standby mode of the parenting assistance agent.

Meanwhile, when the parenting assistance agent for the electronic devices 100 in accordance with the present invention is in a standby mode, the microphone 122 may detect the ambient sound of electronic devices 100 as described above (S110). In a standby mode, when a crying sound from the target is generated, as illustrated in FIG. 5(a), the crying sound may be sensed (detected) through the microphone 122 (S120). Furthermore, the controller 180 may determine whether the characteristic information corresponding to the detected crying sound meets the preset crying sound criteria.

Here, the preset crying sound criteria may include user-saved crying sound information as a basis for determining whether the sensed sound corresponds to the crying sound. For example, the controller 180 may determine whether the type of sound corresponds to a crying sound as a kind of sound, by comparing the information about the characteristics of the sensed sound with the preset crying reference. For another example, the controller 180 may be set up to recognize the voice of a pre-saved subject, so that the parenting assistance agent can be activated only at the target's crying sound to provide a customized guide.

Meanwhile, the controller 180 of the electronic device 100 in accordance with the present invention maintains the operation mode of the parenting assistance agent in a standby mode when the characteristic information corresponding to the sensed crying sound through the microphone 122 does not meet the preset crying sound criteria. Therefore, the microphone 122 also maintains sound an information collection state.

On the other hand, the controller 180 of the electronic device 100 in accordance with the present invention may convert the operation mode of the parenting assistance agent into an active mode when the characteristic information corresponding to the crying sound sensed by the microphone 122 is met with the preset crying sound criteria.

When the parenting assistance agent is activated by a sensed crying sound as a starter word, the controller 180 may analyze the situation information associated with the sensed sound, as shown in FIG. 5(b) (S310). Furthermore, information on the parenting guide may be extracted from the parenting data corresponding to the analyzed situation information.

In this instance, the situation information may include at least one of the date information, information of day of the week, time information, weather information, and location information that the sound is collected through the microphone 122. Further, the situation information may also include information related to current situation information from sound collected through the microphone. However, the situation information is not limited to it and may include information that can infer the current situation via sound.

Meanwhile, referring to FIG. 4, the parenting guide database in accordance with the present invention may include plural parenting data and the target's profile information.

First, FIG. 4(a) is an example of a parenting guide database, showing the target's profile data. Profile data may include the target's name, gender, age and weight information. Furthermore, profile data may be updated periodically by 1) requesting the users to update the data by the controller 180, and 2) by setting the age and weight information of an already stored subject to be updated automatically according to the standard developmental information stored over time, then the controller may request the user to confirm the updated data. Using this profile data, the parenting assistance agent in accordance with the present invention may provide more accurate parenting guide information.

For instance, when a user's voice, such as ‘Tim! Are you hungry?’ is sensed through the microphone 122, the controller 180 may determine the user's speech to the target based on the name information ‘Tim’.

In another example, the weight information of the collected profile information may allow the controller 180 to determine the number of meals per person or the frequency of meal times.

Meanwhile, FIG. 4(b) is an example of a parenting guide database, showing parenting schedule data. The parenting schedule data may be stored by dividing the status of the target into day and time information. In other words, parenting schedule data may be stored differently for each section of the week and for each day of the week, and for each segment, the status information of the subject and the parenting guide information. In this instance, the controller 180 may match the analyzed situation information with the day and time of the week stored in the parenting schedule data to extract the parenting guide information complying with the current situation. For example, when a subject sleeps from 10 to 11 on Tuesday and wakes up and defecates, schedule data may be stored as shown in FIG. 4 (b).

On the other hand, when there is no parenting schedule data in the parenting guide database of the electronic device 100 in accordance with the present invention, the user may be asked to input data via a mobile terminal linked to the electronic device 100 or the electronic device 100. In addition, the parenting schedule data for electronic device 100 in accordance with the present invention may be updated continuously, based on the user's feedback information.

As described above in detail, the controller 180 may extract parenting guide information from parenting data corresponding to the situation information associated with the sound sensed through the microphone. And the controller 180 may output parenting guide information corresponding to the extracted parenting data, as shown in FIG. 5(c) (S140).

In this instance, it is possible to provide the user with parenting guide information in such a way as to include at least one of the acoustic, text, image, vibration, infrared and light signals through the output unit 150. For instance, based on parenting data, when it is determined to be ‘sleep’ time, a voice guide ‘It's a sleeping time.’ can be outputted together with a light signal.

In addition, messages can be transmitted to mobile terminals connected with the electronic device 100 via wired or wireless communication unit 110 in accordance with the present invention. For instance, when the controller 180 in accordance with the present invention sends a notification message to the mobile terminal of users connected with the electronic device 100 via Bluetooth (Bluetooth), the display unit 151 of the mobile terminal may output the text message ‘Sleeping time of Tim’.

Furthermore, the controller 180 in accordance with the present invention may control either of the external devices linked to the electronic device 100. Here, the external device may include at least one of the following: television, computer, audio, mobile terminals, air conditioner and lighting. However, this is an example of an external device that can be connected to the electronic device 100 and does not limit the type of external device thereto.

For instance, the controller 180 may reproduce the classic music by operating an audio device linked to the electronic device 100 while providing the parenting guide, such as ‘It's a sleeping time.’.

Hereinbefore, described is how the electronic device 100 that includes parenting assistance agents in accordance with the present invention can provide parenting guides using stored parenting data.

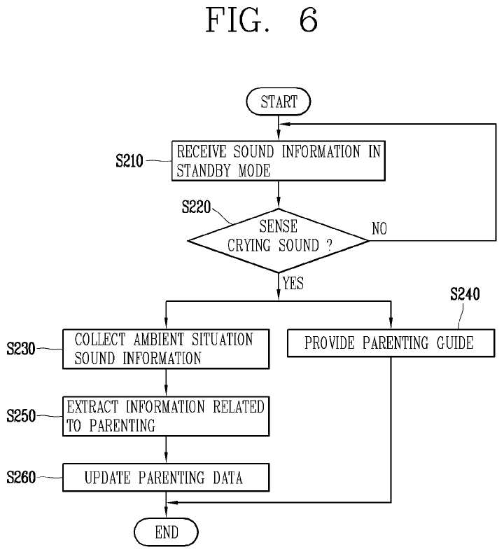

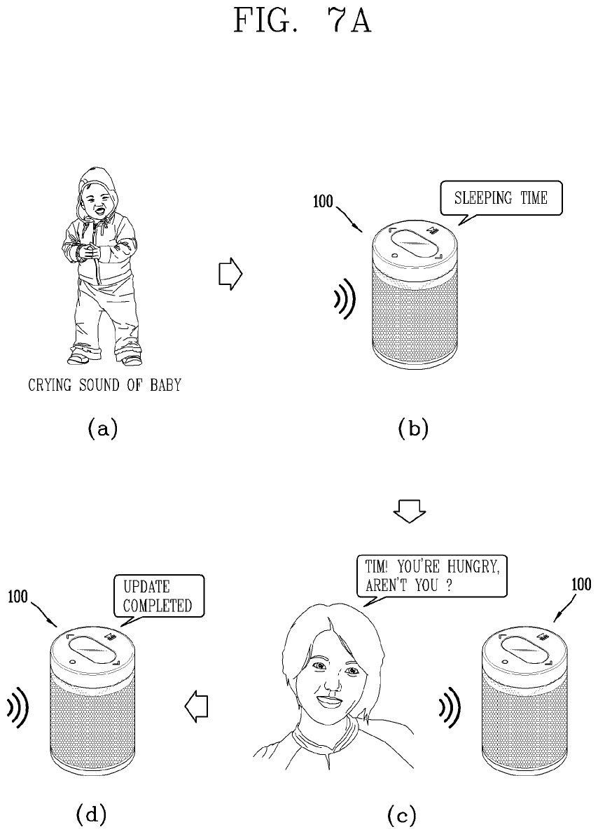

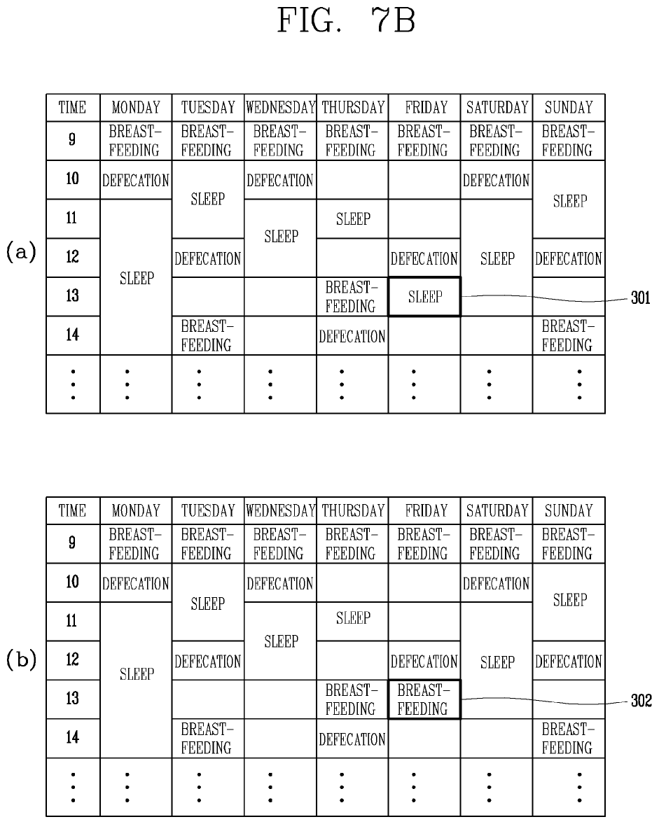

Hereinafter, description will be given of the process by which the electronic device 100 with parenting assistance agents perform feedback on the parenting guide information provided using the sensed sound information. FIG. 6 is a flowchart illustrating a process to update parenting data, using feedback information on the parenting guide provided by an electronic device in accordance with the present invention, and FIG. 7A is a conceptual view illustrating an embodiment that an electronic device provides parenting guide in accordance with the present invention, and FIG. 7B is a conceptual view illustrating an embodiment of a parenting guide database using feedback of an electronic device in accordance with the present invention.

Referring first to FIG. 6, the electronic device 100 in accordance with the present invention may receive sound (voice) in a standby mode of the parenting assistance agent through the microphone 122, as described above in detail (S210). As shown in FIG. 7A(a), when a target's crying sound occurs and the microphone 122 detects the crying sound, it can be determined whether the characteristic information corresponding to the sensed sound meets the preset crying sound (S220). When the characteristic information corresponding to the sensed sound does not satisfy the previously set crying sound, the controller 180 maintains the standby mode of the parenting assistance agent and continues to collect sound through the microphone 122.

When the characteristic information corresponding to the sensed sound satisfies the previously set crying sound, the controller 180 in accordance with the present invention may provide the parenting guide, as shown in FIG. 7A(b), by converting the parenting assistance agent's operation mode to an active mode and extracting the information related to parenting (S240).

Meanwhile, the controller 180 in accordance with the present invention may collect sound information by providing a parenting guide and keeping the microphone 122 in an active state for a preset period of time (S230). Furthermore, the controller 180 may extract data related to parenting from the sounds collected during the preset time and extract feedback information from the extracted data.

Here, the feedback information is information to determine whether the provided parenting guide is consistent with the current situation, based on the sounds collected during the preset time, when the controller 180 in accordance with the present invention provides a parenting guide in response to the sensed crying sound.

Specifically, the controller 180 may collect sound information for the preset time, when a parenting guide is provided. That is, in the active mode of the parenting assistance agent, the controller 180 may activate the microphone 122 to collect sound information to extract the feedback information from the parenting guide provided. In addition, the controller 180 may extract data related to parenting from the collected sound and determine whether the extracted data corresponds to positive or negative information.

Thus, when the provided parenting guide is identical to the current situation of the user and the subject, the controller 180 may extract positive feedback information from the user's sound (voice). On the other hand, when the parenting guides provided do not identical to the current situation of the user and the subject, the controller 180 may extract negative feedback information from the user's sound (voice).

For instance, when the controller 180 in accordance with the present invention provides a parenting guide called ‘It's a sleeping time.’, the sound information collected during the preset time may include information about ‘Tim! Can't you sleep?’. In this instance, the controller 180 may analyze the collected sound information to extract negative feedback information therefrom.

On the other hand, the controller 180 may correct parenting data corresponding to the situation information associated with the sensed crying sound using the extracted feedback information.

The correction of patenting data here means that the extracted feedback information is reflected to the pre-stored parenting data. For instance, when the extracted feedback information corresponds to the negative feedback information, the controller 180 may delete or change the pre-stored parenting data. In addition, when the extracted feedback information corresponds to positive feedback information, the controller 180 may set up to maintain the existing parenting data since the pre-stored parenting data is identical to the actual situation.

On the other hand, when the feedback information extracted above includes negative information about parenting data corresponding to the sensed sound, the controller 180 may maintain the active state of the microphone 122 for a preset period of time so as to receive new parenting guides. Thus, the controller 180 may update (delete or change) parenting data corresponding to the situation information associated with the sensed sound with the collected parenting guide information.

For instance, referring to FIG. 7A, when the controller 180 in accordance with the present invention analyzes the situation information related to the crying sound of the subject, and the situation information is “Friday 13:00” as a result of the analysis, then the parenting guide information corresponding to that situation information may be extracted from the parenting data as shown in the drawing (a) of FIG. 7B. That is, the controller 180 may extract the ‘sleeping’ (301) information from the parenting data and output a parenting guide (a guide message), such as ‘time to sleep’. In this instance, the user may determine if the situation at the time the sound was sensed is identical to the provided parenting guide. Based on the above determination, when the user determines that the target's crying sound is a cry of hunger, the controller 180 may extract negative feedback information based on the collected sound information because the information stored in the parenting data is not identical to the actual situation.

For instance, the controller 180 may sense the user's voice, ‘Tim is not sleepy. You're hungry, aren't you? Let's eat with Mom.’ within the preset time, via the microphone 122. In this instance, the controller 180 may correct the parenting data corresponding to the situation information through the analysis of the sensed sound from ‘Sleep’ (301) to ‘Breast-feeding’ (302), that is, the parenting guide information corresponding to ‘13:00 Friday’ of the parenting data, as shown in (b) of FIG. 7B. In some cases, once the correction of the parenting data is completed, the controller 180 may output a guide voice, ‘Update Complete’ through the output unit 150 to inform the user of the correction.

In another example, when feedback information including negative information is extracted, the controller 180 may activate the microphone 122 for a predetermined time while outputting a message ‘Please enter new parenting data.’. In this instance, when the user outputs a voice saying, ‘Change, 1:00 p.m. on Friday is breast-feeding time’ within a predetermined time, parenting guide information may be corrected from ‘Sleeping’ (301) to ‘Breast-feeding’ (302) in the parenting data. In addition, once correction of the parenting data is completed, the controller 180 may output a guide voice, ‘Update Completed’ voice via the output unit 150 to inform the user of the correction.

Thus, the electronic device 100 in accordance with the present invention may teach the parenting assistance agents using extracted feedback information so as to provide customized parenting guides for users.

Hereinbefore, described is a process to update parenting data using feedback information along with the provision of parenting guides.

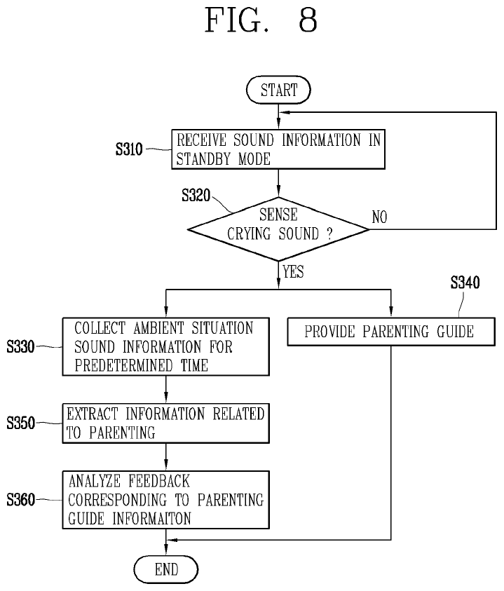

Hereinafter, description will be given, as another example of providing the parenting guide, of a process to convert the accuracy of the parenting guide to points, using the extracted feedback information, referring to FIGS. 8 to 10.

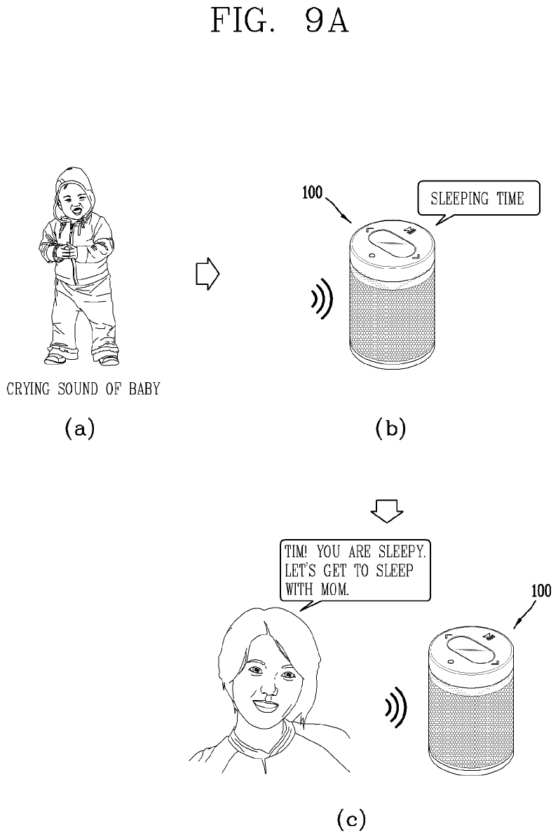

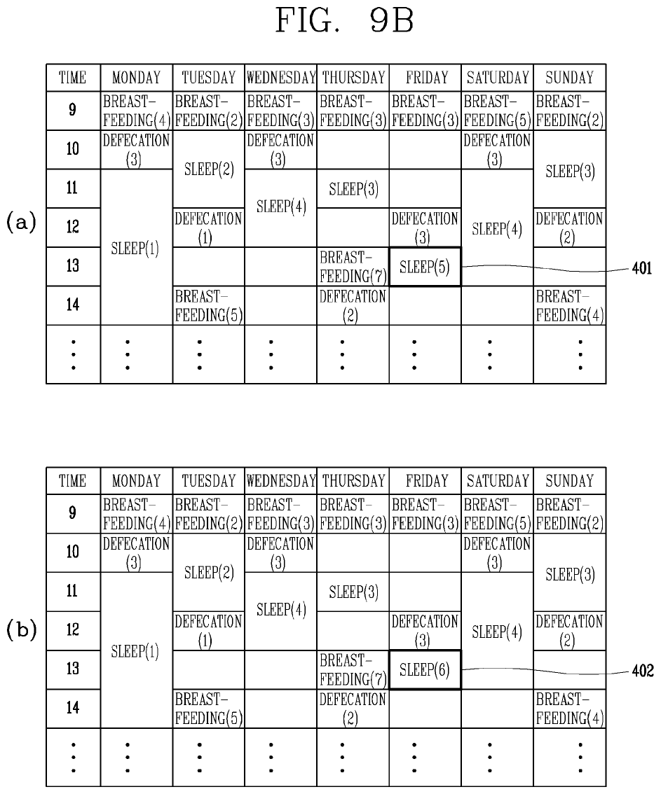

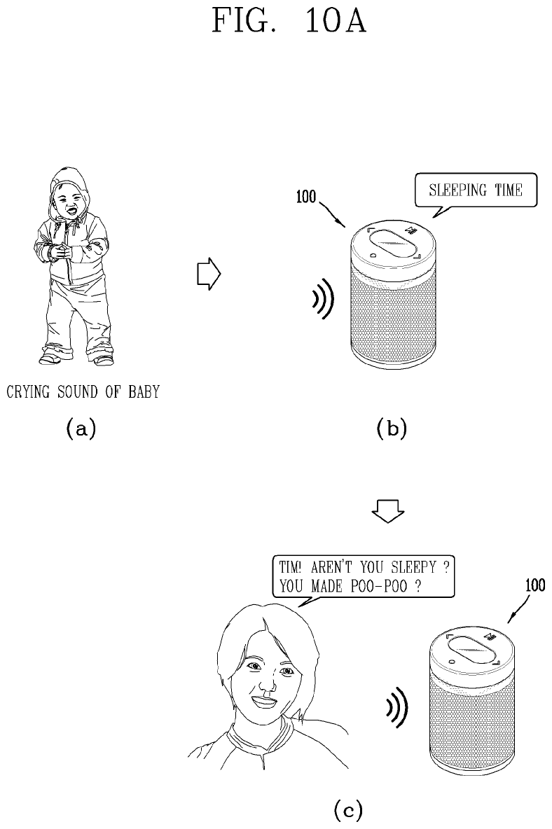

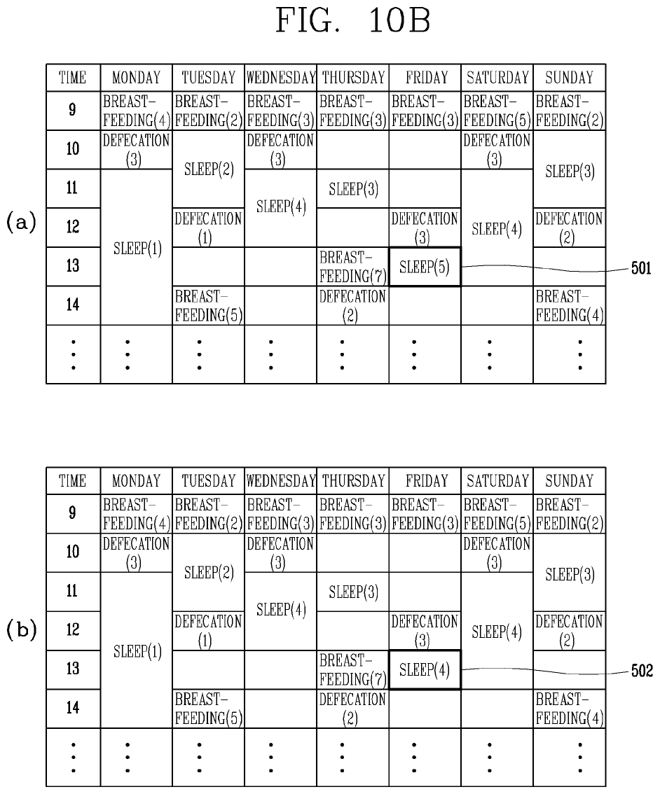

FIG. 8 is a flowchart illustrating a parenting guide provided by an electronic device and a feedback analysis thereon in accordance with the present invention, FIGS. 9A and 9B are conceptual views illustrating embodiments of parenting guide and feedback analysis of an electronic device in accordance with the present invention, and FIGS. 10A and 10B are conceptual views illustrating other embodiments of parenting guide and feedback analysis of an electronic device in accordance with the present invention.

Referring to FIG. 8, the electronic device 100 in accordance with the present invention may receive sound (voice) from the standby mode of the parenting assistance agent via the microphone 122, as described above (S310). When the microphone 122 detects a crying sound, the controller 180 may determine whether the characteristic information corresponding to the sensed sound satisfies the preset crying sound (S320). When the characteristic information corresponding to the sensed sound does not satisfy the preset crying sound, the controller 180 maintains the standby mode of the parenting assistance agent and continues to collect sound through the microphone 122.

When the characteristic information corresponding to the sensed sound satisfies the preset crying sound, the controller 180 in accordance with the present invention may convert the operation mode of the parenting assistance agent to an active mode and extract the information related to parenting to provide a parenting guide (S340).

Meanwhile, the controller 180 may collect sound information by activating the microphone 122 for a preset time, when the parenting guide is output (S330). In addition, the controller 180 may extract data related to parenting from the collected sound information (S350). The controller 180 may extract the feedback information by determining whether the extracted information is identical to the information in the provided parenting guide.

On the other hand, the feedback information extracted above may correct the accuracy point for parenting data corresponding to the situation information analyzed above, depending on whether the analyzed situation information includes positive or negative information about the parenting guide.

Here, accuracy points for parenting data are indicators that provide parenting guides through the collected parenting data, and that is, may determine the accuracy, or reliability, of information collected through additions or subtraction based on the feedback information collected in real time. Therefore, data with high accuracy points may be classified as reliable data, while data with low accuracy points may be classified as less reliable data.

Specifically, the controller 180 in accordance with the present invention may add an accuracy point for the parenting guide information corresponding to the situation information analyzed above, provided that the feedback information extracted above is positive for the parenting guide information corresponding to the situation information analyzed above. That is, when the provided parenting guide is judged to be identical to the actual situation, the controller 180 may add an accuracy point for the corresponding parenting guide information.

For instance, when a crying sound is generated from the target, as shown in the drawing of (a) in FIG. 9A, the controller 180 of the electronic device 100 in accordance with the present invention may sense ambient sound around the electronic device 100 through the microphone 122. When the parenting assistance agent is converted into an active mode through the sensed sound, parenting guide information corresponding to ‘sleep (accuracy point: 5 points)’ (401) may be extracted from the parenting data corresponding to the situation information associated with the sensed sound (a) of FIG. 9B. Accordingly, as shown in the drawing of (a) in FIG. 9A, the electronic device 100 in accordance with the present invention may output a parenting guide called ‘Time to Sleep’. On the other hand, users who are provided with the parenting guide may determine whether the current situation and the guided parenting guide information are identical to each other. As a result, when it is determined that the guided parenting guide and the current situation are identical to each other, the user may respond as, ‘Tim, you are sleepy.’, ‘Sleep with Mom.’, as shown in the drawing of (c) in FIG. 9A. In other words, the electronic device 100 in accordance with the present invention may collect sound information from the surrounding area by activating the microphone 122 for a predetermined time after the parenting guide is provided. For example, when the sound information, such as ‘Tim, you are sleepy.’, ‘Sleep with Mom.’ is collected, the parenting guide (‘It's a sleeping time.’) and the analyzed situation information (‘Tim, you are sleepy. Sleep with Mom.’) are identical to each other, upon analysis so that it is possible to extract feedback information corresponding to positive information. Thus, as shown in the drawing of (b) in FIG. 9B, the accuracy point of the parenting data may be added from 5 points (401) to 6 points (402). In other words, the higher the accuracy point, the more reliable the data is.

On the other hand, the controller 180 may deduct the accuracy point for the parenting guide information corresponding to the situation information analyzed above, provided that the feedback information extracted above is negative information about the parenting guide information corresponding to the analyzed situation information.

For instance, referring to FIG. 10, when a target cries as shown in the drawing (a) in FIG. 10A, the controller 180 of the electronic device (100) in accordance with the present invention may sense ambient sound around the electronic device 100 via the microphone 122. When the parenting assistance agent is converted into an active mode through the sensed sound, it is possible to provide a parenting guide by extracting parenting guide information from parenting data corresponding to the situation information associated with the sensed sound ((a) of FIG. 10B). That is, as shown in the drawing of (b) in FIG. 10A, the electronic device 100 in accordance with the present invention may output a parenting guide called “Sleeping Time” based on parenting data. However, users who are provided with these parenting guides may determine whether the current situation and the guided parenting guide information are identical to each other. Therefore, when it is determined that the guided parenting guide information is not identical to the current situation, the user may make a response, such as ‘Tim, not sleepy? You made poo-poo.’ as shown in the drawing of (c) in FIG. 10A. That is, the controller 180 in accordance with the present invention may collect sound information from the surrounding area by activating the microphone 122 for a predetermined time after the parenting guide is provided. For instance, the controller 180 may, when sound information, such as ‘Tim, not sleepy? You made poo-poo.’ is collected, analyze the collected sound. That is, since the guided parenting guide (‘time to sleep’) and the analyzed situation information (‘Tim, not sleepy? You made poo-poo.’) are inconsistent with each other, the controller 180 may extract feedback information that corresponds to negative information. Therefore, as shown in the drawing of (b) in FIG. 10B, the accuracy point of the parenting guide information may be reduced from 5 points (501) to 4 points (502). In other words, the lower the accuracy point, the less reliable the data is.

On the other hand, the controller 180 in accordance with the present invention may, when the accuracy point for the parenting data corresponding to the analyzed situation information does not satisfy the preset satisfaction criteria, delete the parenting guide information of the parenting data corresponding to the analyzed situation information. Further, the controller 180 may replace previously stored parenting guide information with new data to store.

In addition, though not shown, the controller 180 in accordance with the present invention may, when feedback information including negative information is extracted, deduct the accuracy point and, thereafter, determine the accuracy point for the ‘defecation’ after adding ‘defecation’ to data corresponding to ‘Friday 13 o'clock’ as well as deducting the accuracy point.

As described hereinbefore, the electronic device 100 in accordance with the present invention can activate the parenting assistance agent with a crying sound as a starter word, and provide the user with a parenting guide based on the detected crying sound and parenting data. Therefore, the user can be provided with a parenting guide without further manipulation to be provided with the parenting guide, since the parenting assistance agent is activated by a crying sound as a starter word.

Furthermore, the present invention provides the electronic device 100 that extracts feedback information on the provided parenting guide and reflects the extracted feedback information to the parenting data. Thus, by updating the existing parenting data, customized parenting guides can be provided with a greater reliability.

The present disclosure can be implemented as computer-readable codes in a program-recorded medium. The computer readable medium includes all kinds of recording devices in which data readable by a computer system is stored. Examples of such computer-readable media may include hard disk drive (HDD), solid state disk (SSD), silicon disk drive (SDD), ROM, RAM, CD-ROM, magnetic tape, floppy disk, optical data storage element and the like. Also, the computer-readable medium may also be implemented as a format of carrier wave (e.g., transmission via an Internet). The computer may include the controller 180 of the terminal. The above detailed description should not be limitedly construed in all aspects and should be considered as illustrative. The scope of the present disclosure should be determined by rational interpretation of the appended claims, and all changes within the scope of equivalents of the present disclosure are included in the scope of the present disclosure.

What is claimed is:

1. An electronic device including a parenting assistance agent operated by one of a standby mode and an active mode, the device comprising:
a microphone configured to sense sound; and
a controller configured to convert, when characteristic information corresponding to sound sensed through the microphone in the standby mode satisfies a preset crying sound criteria, an operation mode of the parenting assistance agent into an active mode, to extract parenting data corresponding to analyzed situation information after analyzing situation information related to the sound, and to output parenting guide information corresponding to the extracted parenting data.

2. The electronic device of claim 1, wherein the controller is configured to maintain the microphone in an active state for a preset time based on output of the parenting guide information, and to extract feedback information from the sound collected for the preset time.

3. The electronic device of claim 2, wherein the controller is configured to correct parenting data corresponding to the analyzed situation information, using the extracted feedback information.

4. The electronic device of claim 3, wherein the controlled is configured to maintain the microphone in an active state for a preset time to receive an input of new parenting guide information, when the extracted feedback information includes negative information on the parenting data corresponding to the analyzed situation information.

5. The electronic device of claim 4, wherein the controller is configured to update parenting data corresponding to the analyzed situation information with the new parenting guide information.

6. The electronic device of claim 3, wherein an accuracy point for parenting data corresponding to the analyzed situation information is corrected, depending on whether the extracted feedback information includes positive information on the parenting data corresponding to the analyzed situation information.

7. The electronic device of claim 6, wherein the controller is configured to add an accuracy point on parenting data corresponding to the analyzed situation information, when the extracted feedback information includes positive information on the parenting data corresponding to the analyzed situation information, and to deduct an accuracy point on the parenting data corresponding to the analyzed situation information, when the extracted feedback information includes negative information on the parenting data corresponding to the analyzed situation information.

8. The electronic device of claim 7, wherein the controller is configured to delete parenting data corresponding to the analyzed situation information, when the accuracy point on parenting data corresponding to the analyzed situation information does not satisfy preset satisfaction criteria.

9. The electronic device of claim 1, wherein the situation information includes at least one of date information, information of day of the week, time information, weather information and location information of sound that is collected through the microphone, and characteristic information of a crying sound corresponding to the collected sound.

10. The electronic device of claim 9, wherein the controller is configured to extract parenting data that is matched with the situation information when the sound is collected, from parenting guide database including plural parenting data that are matched, respectively, with at least one of the situation information.
